(19) United States
(12) Patent Application Publication
(10) Pub. No.: US 2011/0141241 A1
(43) Pub. Date: Jun. 16, 2011

(54) MODULE FOR THREE-DIMENSIONAL CAMERA

(75) Inventors: Hyung Kun LEE, Daejeon (KR); Kwang Suk Yang, Daejeon (KR); Nak Jin Choi, Daejeon (KR); Sun Kyung Jung, Daejeon (KR); Kang Ho Park, Daejeon (KR); Jong Dae Kim, Daejeon (KR)

(73) Assignee: Electronics and Telecommunications Research Institute, Daejeon (KR)

(21) Appl. No.: 12/781,155

(22) Filed: May 17, 2010

(30) Foreign Application Priority Data
Dec. 11, 2009 (KR) 10-2009-0123071

(51) Int. Cl. H04N 13/02

(52) U.S. Cl. 348/47; 348/E13.074

(57) ABSTRACT

Provided is a convergence control module for a three-dimensional (3D) camera that can be operated with low power to reduce power consumption, which has been a problem in the 3D camera. A 3D camera module includes at least one camera module, a moving guide for supporting the camera module and providing a moving path, a control driver for moving the camera module along the moving guide, and a control unit for controlling the control driver.

### CROSS-REFERENCE TO RELATED APPLICATION

This application claims priority to and the benefit of Korean Patent Application No. 10-2009-0123071, filed Dec. 11, 2009, the disclosure of which is incorporated herein by reference in its entirety.

### BACKGROUND

1. Field of the Invention

The present invention relates to a convergence control module for a three-dimensional (3D) camera, which includes a polymer driver that can be operated with low power to reduce power consumption, which has become a problem in the 3D camera. More particularly, the present invention relates to a camera module capable of mechanically controlling horizontal movement of the camera module using biomimetics to make a 3-dimensional image, and enabling lower power driving using a polymer driver in a main actuator of a convergence control module in a biomimetic machine.

2. Discussion of Related Art

Almost conventional camera modules adjust a convergence through electronic control to make a realistic 3D image. In this case, a 3D camera can be easily manufactured. However, images obtained from the camera modules form a 3D image through image processing, or more specifically, horizontal movement and composition to adjust a convergence, causing loss to the images. In addition, since two images having a different parallax are artificially composed to form an unnatural 3D image, it is difficult to see the 3D images for a long time.

A conventional mechanically horizontally movable 3D camera employs a method of manually moving a camera horizontally or a method of moving a camera using an actuator such as a voice coil motor (VCM) having large power consumption. The manual type must manually move a camera module horizontally to adjust a convergence whenever a viewing object varies, making it impossible to make 3D images in real time. In addition, the VCM actuator type increases power consumption to cause a problem in use of a portable camcorder. For this reason, the present invention provides a 3D camera module capable of making a 3D image in real time with low power, solving problems of the conventional art.

### SUMMARY OF THE INVENTION

The present invention is directed to providing a 3D camera module capable of automatically controlling a convergence with low power in a biomimetic manner.

According to one aspect of the present invention, a three-dimensional camera module includes: at least one camera module; a moving guide for supporting the camera module and providing a moving path; a control driver for moving the camera module along the moving guide; and a control unit for controlling the control driver.

The control unit may biomimetically operate the control driver to horizontally move the camera module. One end of the control driver may be in contact with the camera module, and the control driver may be expanded or compressed to move the camera module. The three-dimensional camera module may further include a wedge disposed at one end of the control driver and in contact with one surface of the camera module. Here, one surface of the camera module may be inclined to project toward the wedge as it becomes farther from the wedge, and when the control driver is expanded or compressed, the wedge may push one surface of the camera module to move the camera module. The three-dimensional camera module may further include: a wedge in contact with one surface of the camera module; and a lever having a fixing point formed between the wedge and the control driver, one end in contact with the control driver, and the other end in contact with the wedge. Here, one side of the camera module may be inclined to project from the wedge as it becomes farther from the wedge, and when the control driver is expanded or compressed, the wedge may vertically move to move the camera module. The three-dimensional camera module may further include a lever having a hinge structure, between which the control driver is disposed, and in contact with the camera module. Here, when the control driver is compressed or expanded, the lever having the hinge structure may be widened or closed to move the camera module. The control driver may be a polymer driver.

### BRIEF DESCRIPTION OF THE DRAWINGS

The above and other features of the present invention will be described in reference to certain exemplary embodiments thereof with reference to the attached drawings in which:

FIG. 1 is a block diagram of a horizontal movement stereo 3D camera in accordance with an exemplary embodiment of the present invention;

FIG. 2 is a perspective view of a convergence control module of a biomimetic low power 3D camera employing a polymer driver in accordance with an exemplary embodiment of the present invention;

FIG. 3 is a perspective view of a convergence control module of a biomimetic low power 3D camera employing a polymer driver and a wedge structure in accordance with an exemplary embodiment of the present invention;

FIG. 4 is a perspective view of a convergence control module of a biomimetic low power 3D camera, in which a wedge is driven by a polymer driver and a lever, in accordance with an exemplary embodiment of the present invention;

FIG. 5 is a perspective view of a convergence control module of a biomimetic low power 3D camera, in which a polymer driver is disposed between hinge structures, in accordance with an exemplary embodiment of the present invention.

### DETAILED DESCRIPTION OF EXEMPLARY EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

The above-mentioned and further aspects of the present invention will be more apparent from the following description with reference to the accompanying drawings. Hereinafter, the present invention will be described in detail so that the following embodiments can be readily understood and implemented by those skilled in the art. In addition, for the convenience of description, only a portion of a wafer will be symmetrically illustrated.

Hereinafter, the present invention will be described in detail with reference to the drawings.

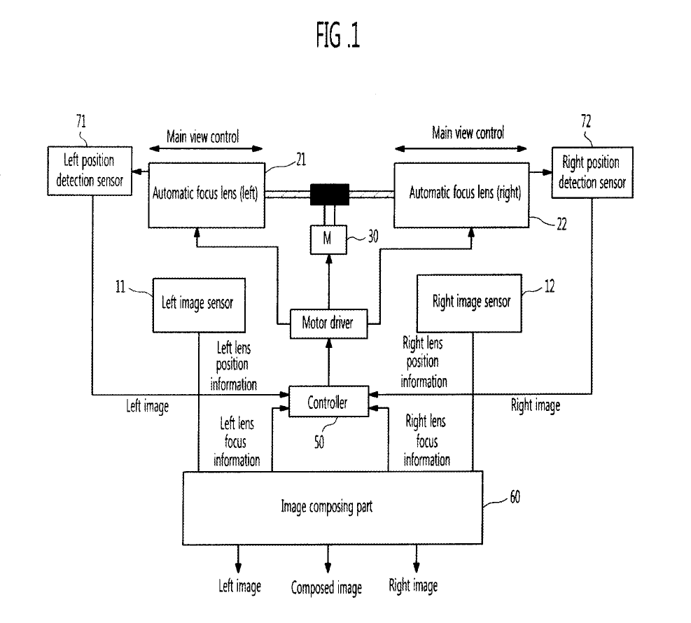

FIG. 1 is a block diagram of a horizontal movement stereo 3D camera in accordance with an exemplary embodiment of the present invention. The 3D camera includes camera modules, which are stereo 3D camera systems modeled after a human sight system, including left and right image sensors 11 and 12, an automatic focus lens module for forming images on the respective image sensors 11 and 12, a left position detection sensor 71 for detecting a motor position of a left automatic focus lens 21, a right position detection sensor 72 for detecting a motor position of a right automatic focus lens 22, a motor 30 for adjusting a distance between the left and right automatic focus lenses 21 and 22 to adjust a convergence, and a motor driver 40 for controlling a drive state of the motor in response to a motor drive signal of a controller 50, which will be described. In addition, the 3D camera includes the controller 50 for calculating a distance between the left and right lenses 21 and 22 using the motor position information of the left automatic focus lens 21 and the motor position information of the right automatic focus lens 22 input from the left position detection sensor 71 and the right position detection sensor 72 and controlling the motor driver 40, and an image composing part 60 for composing left and right images from the camera modules into a single 3D image.

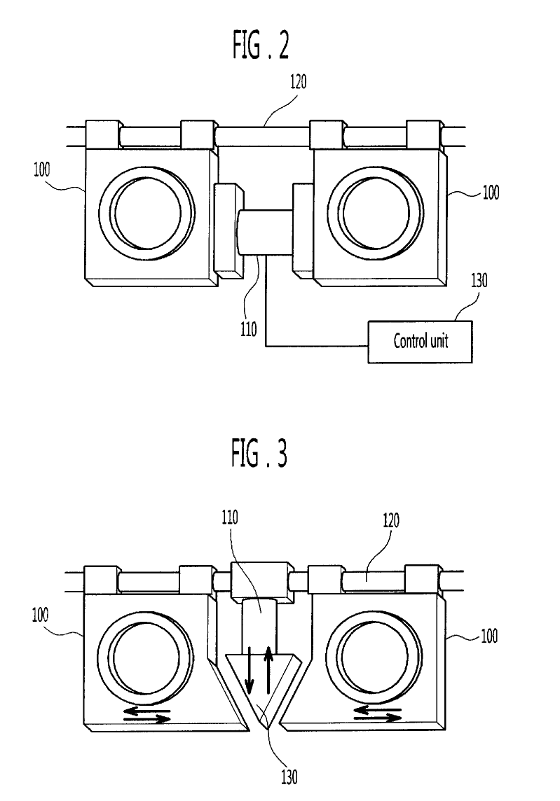

FIG. 2 is a perspective view of a convergence control module of a biomimetic low power 3D camera employing a polymer driver in accordance with an exemplary embodiment of the present invention. Referring to FIG. 2, the 3D camera in accordance with the present invention includes at least one camera module 100, a moving guide 120 for supporting the camera module and providing a moving path of the camera module, and a convergence control driver 110 for moving the camera module along the moving guide to control a convergence. In addition, the 3D camera further includes a control unit 130 for controlling the control driver 110.

The convergence control unit 130 operates the convergence control driver 110 in a biomimetic manner to horizontally move the camera module 100 to photograph left and right images, which will be used to make a 3D image, during the convergence control of the camera module 100.

Biomimetics, a theory of operating a 3D camera using a parallax difference, is used in a 3D camera technique that can provide a realistic image and dialogue, like a human actually sees. The convergence control unit 130 drives the convergence control driver 110 to control a parallax difference of the camera module 100 to make a natural 3D image having distance and depth perception, not a 2D image, as when a human's left and right pupils focus an object.

The convergence control driver 110 is disposed to be in contact with the camera module 100. Therefore, the convergence control driver 110 employing a polymer driver is horizontally expanded or compressed to directly move each camera module 100 horizontally. While FIG. 2 illustrates two cameras, the number of cameras is not limited thereto.

FIG. 3 is a perspective view of a convergence control module of a biomimetic low power 3D camera employing a polymer driver and a wedge structure in accordance with an exemplary embodiment of the present invention. Referring to FIG. 3, the 3D camera in accordance with the present invention includes camera modules 100, a convergence control driver 110, and a moving guide 120, along which the camera modules move.

In addition, a convergence control amplification wedge 300 disposed at one end of the convergence control driver 110 and in contact with one side of the camera module 100 is provided to amplify movement in accordance with 1 the convergence. The convergence control driver 110 employs a polymer driver.

The convergence control amplification wedge 300 is disposed between the camera modules 100, and side surfaces of the camera modules 100 in contact with the convergence control amplification wedge 300 are inclined to project toward the wedge 300 as they become farther from the wedge 300. Horizontal expansion/compression of the polymer driver 110 vertically drives the convergence control amplification wedge 300 to push one surface of the camera modules 100 to horizontally move the camera modules 100. The camera modules 100 may include a spring unit disposed at a connection part with the moving guide 120 so that the camera modules 100 can return to their original positions when the wedge 300 returns to its original position. While FIG. 3 illustrates two cameras, the number of cameras is not limited thereto.

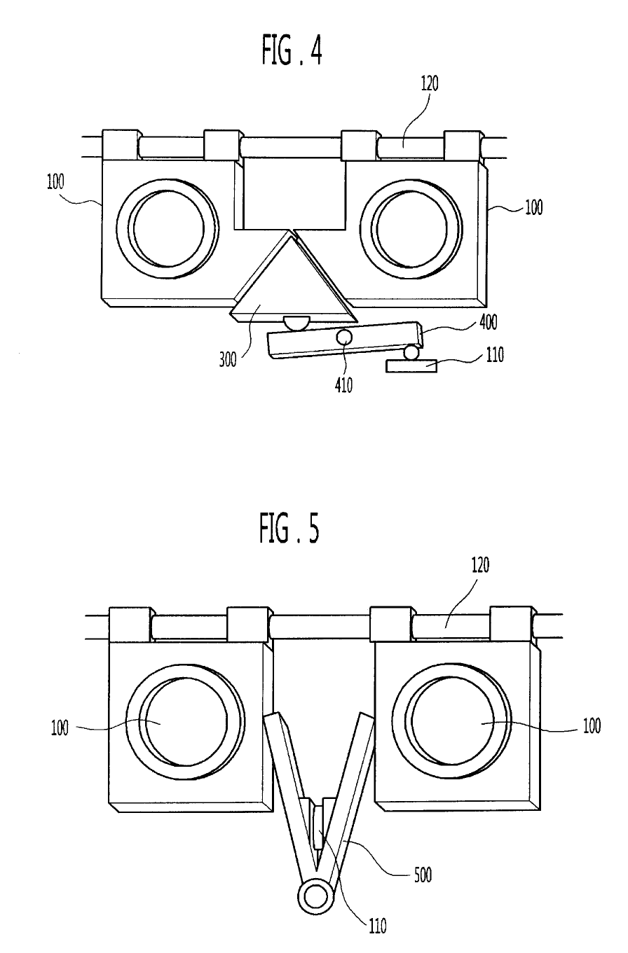

FIG. 4 is a perspective view of a convergence control module of a biomimetic low power 3D camera, in which a wedge is driven by a polymer driver and a lever, in accordance with an exemplary embodiment of the present invention. Referring to FIG. 4, the 3D camera in accordance with the present invention includes camera modules 100, a convergence control driver 110, and a moving guide 120, along which the camera modules move.

The convergence control amplification wedge 300 is in contact with one surfaces of the camera modules 100, and a convergence control lever 400 can be rotated about a lever shaft 410 fixed between the convergence control amplification wedge 300 and the convergence control driver 110. In addition, one end of the convergence control lever 400 is connected to the convergence control driver 110, and the other end of the convergence control lever 400 is connected to the convergence control amplification wedge 300. One sides of the camera modules 100 are inclined to project as they become farther from the wedge. When one end of the convergence control lever 400 is vertically rotated by the convergence control driver 110, the convergence amplification wedge 300 is vertically rotated by the lever 400 in an opposite direction. As a result, it is possible to horizontally move the camera modules 100.

The camera modules 100 may include a spring unit disposed at a connection part with the moving guide 120 so that the camera modules 100 can return to their original positions when the wedge 300 returns to its original position.

While FIG. 4 illustrates two cameras, the number of cameras is not limited thereto.

FIG. 5 is a perspective view of a convergence control module of a biomimetic low power 3D camera, in which a polymer driver is disposed between hinge structures, in accordance with an exemplary embodiment of the present invention.

Referring to FIG. 5, the 3D camera in accordance with the present invention includes camera modules 100, a convergence control driver 110, and a moving guide 120, along which the camera modules move. A convergence control lever 500 is driven like a hinge by the convergence control driver 110 so that the camera modules 100 can be horizontally driven.

The convergence control lever 500 has a hinge structure in which two surfaces are engaged with each other and in contact with the 3D camera modules 100. The convergence control driver 110 is disposed between two surfaces of the hinge to fold or spread the two surfaces of the hinge through compression and expansion thereof, moving the 3D camera modules.

While FIG. 5 illustrates two cameras, the number of cameras is not limited thereto.

As can be seen from the foregoing, a 3D camera module that can automatically control a convergence with lower power in a biomimetic manner, including a polymer driver as a convergence control actuator is provided. Therefore, it is possible to make a realistic 3D image with low power in real time by controlling a convergence using the 3D camera in accordance with the present invention.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A three-dimensional camera module comprising:
one or more camera modules;
a moving guide for supporting the camera module and providing a moving path;
a control driver for moving the camera module along the moving guide; and
a control unit for controlling the control driver.

2. The three-dimensional camera module of claim 1, wherein one end of the control driver is in contact with the camera module, and the control driver is expanded or compressed to move the camera module.

3. The three-dimensional camera module of claim 1, further comprising a wedge disposed at one end of the control driver and in contact with one surface of the camera module,
wherein one surface of the camera module is inclined to project toward the wedge as it becomes farther from the wedge, and
when the control driver is expanded or compressed, the wedge pushes one surface of the camera module to move the camera module.

4. The three-dimensional camera module of claim 1, further comprising:
a wedge in contact with one surface of the camera module; and
a lever having a fixing point formed between the wedge and the control driver, one end being in contact with the control driver and the other end being in contact with the wedge,
wherein one side of the camera module is inclined to project from the wedge as it becomes farther from the wedge, and
when the control driver is expanded or compressed, the wedge vertically moves to move the camera module.

5. The three-dimensional camera module of claim 1, further comprising:
a lever having a hinge structure, between which the control driver is disposed, and in contact with the camera module,
wherein, when the control driver is compressed or expanded, the lever having the hinge structure is widened or closed to move the camera module.

6. The three-dimensional camera module of claim 1, wherein the control unit biomimetically operates the control driver to horizontally move the camera module to photograph left and right images, which are to be used for a three-dimensional image.

7. The three-dimensional camera module of claim 1, wherein the control driver is a polymer driver.
